(19) United States
(12) Patent Application Publication
(10) Pub. No.: US 2008/0080391 A1
(43) Pub. Date: Apr. 3, 2008

(54) METHOD AND APPARATUS FOR SUPPORTING AN ASYMMETRIC TRANSPORT NETWORK

(75) Inventors: CHENG-HONG HU, SAN RAMON, CA (US); KUO-HUI LIU, SAN RAMON, CA (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., RENO, NV (US)

(21) Appl. No.: 11/536,732

(22) Filed: Sep. 29, 2006

(51) Int. Cl. H04L 12/56

(52) U.S. Cl. 370/254; 370/390

(57) ABSTRACT

A method and apparatus for supporting an asymmetric transport network is disclosed. An apparatus that incorporates teachings of the present disclosure may include, for example, a network element having a number of bidirectional switching cards each logically reconfigured as at least one among ingress and egress switching elements for transporting asymmetric unidirectional packet traffic. Additional embodiments are disclosed.

### FIELD OF THE DISCLOSURE

The present disclosure relates generally to communication systems, and more specifically to a method and apparatus for supporting an asymmetric transport network.

### BACKGROUND

Today's Internet Service Providers (ISPs) deploy data services that are in large part asymmetric. That is, downstream data traffic tends to be significantly higher in usage than upstream traffic (e.g., 6 Mbps downstream versus 1 Mbps upstream). This is in part due to end users downloading more content than they originate themselves. Consequently, an ISP's communication network under utilizes bidirectional switching elements for upstream traffic, which is costly to the service provider.

Cisco Systems™ has introduced an asymmetric transport system referred to as “Asymmetric Link Aggregation.” Asymmetric link aggregation aggregates an unequal number of unidirectional links in each direction to form an asymmetric link group that addresses the asymmetry in ISP networks. The solution introduced by Cisco Systems™ utilizes bidirectional switching cards with unused ports to create the effect of an asymmetric transport.

A need arises, however, for a method and apparatus that supports an asymmetric transport network that efficiently utilizes switching card resources.

### BRIEF DESCRIPTION OF THE DRAWINGS

FIG. 1 depicts an exemplary embodiment of a communication system;

FIG. 2 depicts an asymmetrical packet-switched network;

FIGS. 3-7 depict exemplary embodiments of bidirectional switching cards reconfigured as unidirectional switching cards to accommodate the resource needs of the asymmetrical packet-switched network; and

FIG. 8 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for supporting an asymmetric transport network.

In a first embodiment of the present disclosure, an apparatus can have a bidirectional switching card reconfigured as at least one among ingress and egress switching elements for transporting unidirectional packet traffic. The bidirectional switching card can have a line module and corresponding port adapters, and wherein logical portions of said line module and port adapters are reconfigured as the ingress and egress switching elements.

In a second embodiment of the present disclosure, a network element can have a plurality of bidirectional switching cards each logically reconfigured as at least one among ingress and egress switching elements for transporting asymmetric unidirectional packet traffic.

In a third embodiment of the present disclosure, a computer-readable storage medium can have computer instructions for arranging a bidirectional switching card as at least one among ingress and egress switching elements for transporting unidirectional packet traffic.

In a fourth embodiment of the present disclosure, a method can have the step of configuring a line module and corresponding port adapters of a bidirectional switching card as at least one among ingress and egress switching elements for transporting unidirectional packet traffic.

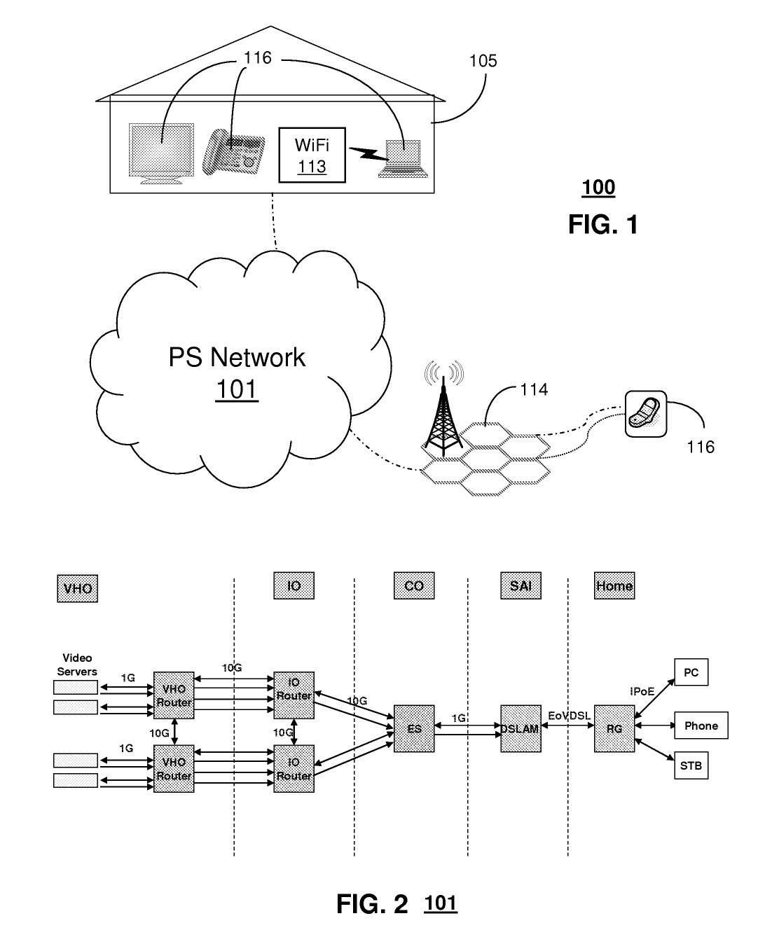

FIG. 1 depicts an exemplary embodiment of a communication system 100. The communication system 100 can comprise a packet-switched (PS) network 101 managed by an Internet Service Provider (ISP) supporting packetized voice, video, and data directed to messaging devices 116 such as an IPTV terminal, a Voice over IP (VOIP) terminal, and/or a computer communicating over for example a WiFi 113 or xDSL interface. For wireless applications, the communication system 100 can further comprise a plurality of wireless base stations 114 operating according to a frequency reuse architecture that provides over-the-air coverage to a large geographic region of roaming messaging devices 116 consuming voice, data and video services. The base stations 114 can operate according to any number of protocols including GSM-GPRS, EDGE, CDMA-1X, EV/DO, UMTS, and other known and next generation cellular communications technologies. Some of the messaging devices 116 can also operate as multimode devices. Accordingly, said roaming devices can utilize POTS or VoIP services when in the building 105, or cellular services outside the building 105.

FIG. 2 depicts an exemplary block diagram of the PS network 101 as an asymmetrical packet-switched network (herein referred to as asymmetric network 101) comprised of a number of common packet switching cards conforming to any number of packet-switching protocols such as the Internet Protocol (IP), Multi-Protocol Label Switching (MPLS), Frame Relay (FR), Asynchronous Transfer Mode (ATM), and so on. In this illustration, a video hub office (VHO) transmits video services over 1 Giga bit per second (1 G) lines to a VHO router. The VHO router multiplexes several 1 G lines into 10 Gbps (10 G) lines which are distributed to 10 routers which terminate at a central office (CO). At the CO, the 10 G lines are de-multiplexed into 1 G lines which are distributed to one or more Digital Subscriber Line Access Multiplexer (DSLAMs) which in turn distribute sub portions of the packet traffic (e.g., 3 Mbps to 60 Mbps) to residential gateways residing in each of the buildings 105 which is then utilized by messaging devices 116 such as a computer, VoIP phone, set top box, and so on.

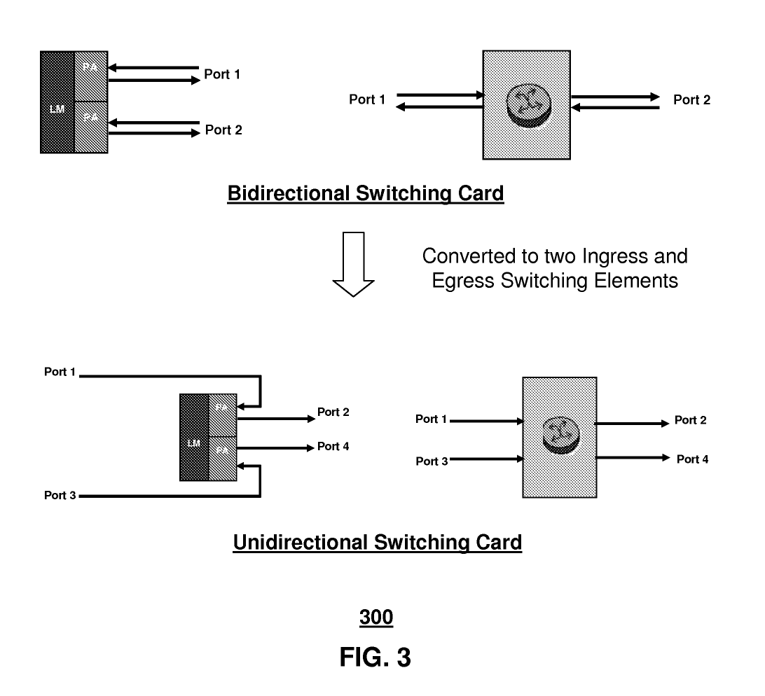

It should be evident from the communication links between the routers of FIG. 2 that not all links are bidirectional. Most links a unidirectional (downstream) while a smaller subset is bidirectional (upstream and downstream). The asymmetry depicted in FIG. 2 is intended to provide an improved utilization of upstream and downstream resources. It is well known in practice that end users of the asymmetric network 101 consume much more downstream traffic than they produce upstream. Consequently, a large number of conventional bidirectional switching cards in FIG. 2 are configured as unidirectional switching cards while a small subset of bidirectional switching cards are utilized as intended to accommodate this asymmetry. FIGS. 3-6 depict exemplary embodiments of bidirectional switching cards reconfigured as unidirectional switching cards for utilization in the asymmetric network 101.

FIG. 3 depicts a process for reconfiguring a common bidirectional switching card comprising a line module (LM) and corresponding port adapters (PAs) into a unidirectional switching card. The bidirectional switching card has two bidirectional ports (Ports 1 and 2). Software changes can be made to the bidirectional switching card so that logical portions of the line module and the port adapters can be reconfigured as two unidirectional ingress and egress switching elements as shown in the middle of FIG. 3. The logical equivalent of two unidirectional ingress and egress switching cards is shown at the bottom of FIG. 3. Hence, a bidirectional switching card having two bidirectional ports (Ports 1 and 2) can be configured to a unidirectional switching card having two ingress ports (Ports 1 and 3) and two corresponding egress ports (Ports 2 and 4) with the ability to switch packet traffic between egress ports.

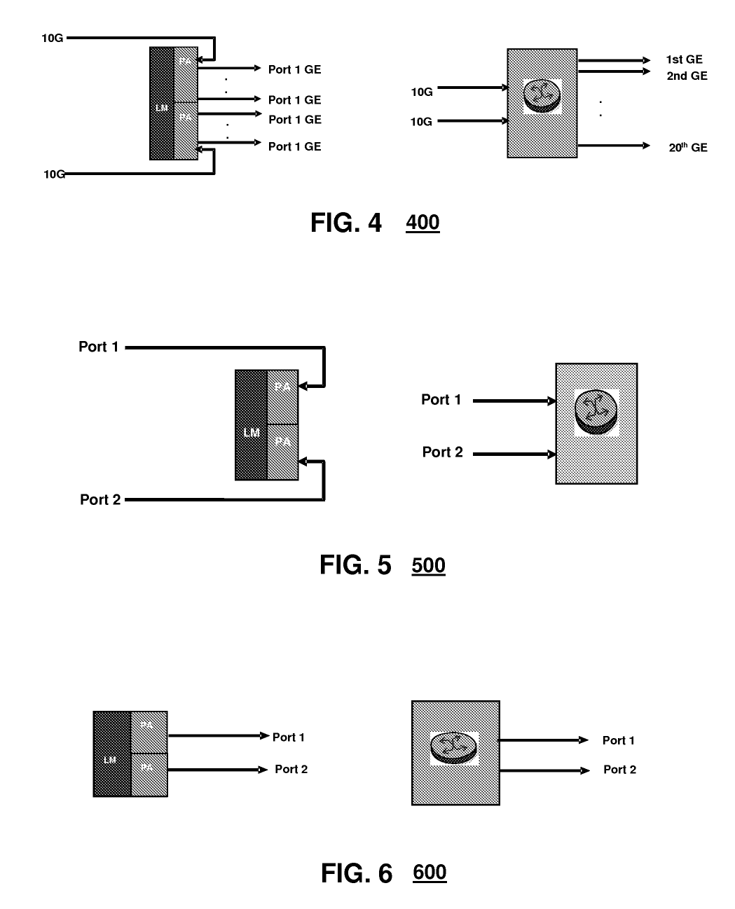

Alternatively, a bidirectional switching card can be reconfigured with software to an A ingress port to B egress port unidirectional switching card wherein the egress ports operate at the same or a subset data rate of the ingress ports. This reconfiguration is shown in FIG. 4. In this illustration two 10 G ingress ports each generate ten 1 G ports-hence, a total of twenty 1 G ports. The resulting unidirectional switching card can switch 1 G packet traffic from the 10 G ingress ports to any one of the twenty 1 G egress ports.

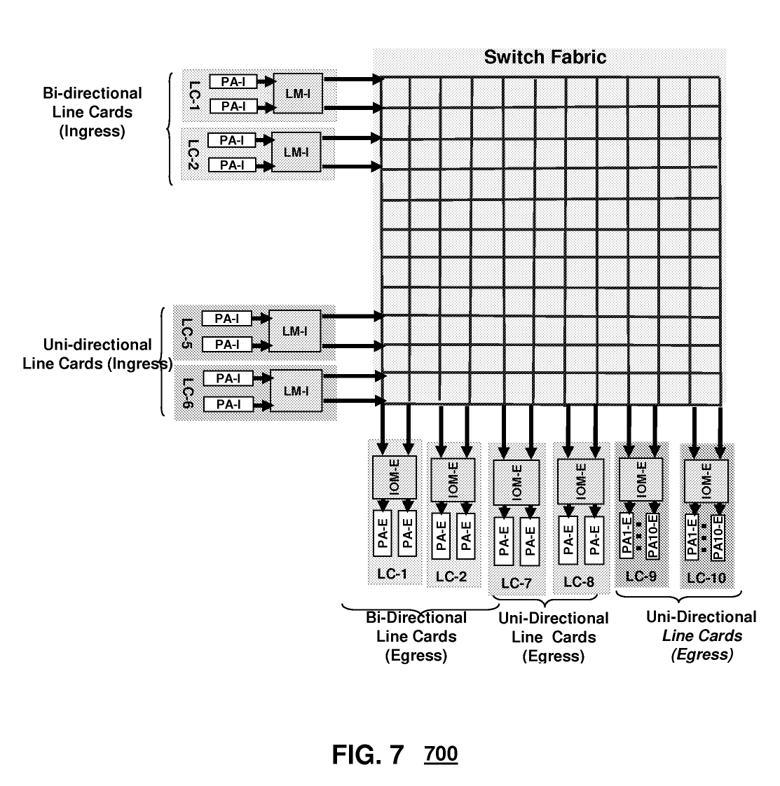

The ingress to egress data rates can be generically described as follows. Assume, for example, that a switching fabric represented by the bidirectional switching card (or a combination of reconfigured unidirectional switching cards as shown in FIG. 7) has a switching fabric data rate of S. Further assume that ingress ports have a data rate of M, and egress ports have a switching data rate of N. An aggregate ingress data rate for one or more ingress switching elements can be represented by the product of A and M so long as this product is less than or equal to S. Similarly, an aggregate egress data rate for one or more egress switching elements can be represented the product of B and N so long as said product is less than or equal to S. It should be further noted that M and N can each represent a series of different data rates (e.g., M1, M2. . . Mn and N1, N2, . . . Nn).

With these concepts in mind, FIG. 4 can represent Ethernet ingress ports operating at M=10 G, with two ports (A=2), with a switching fabric operating at S=20 G. The egress ports in this illustration operate at N=1 G with 20 egress ports (B=20). For this use case, M*A <=S and N*B <=S. Accordingly, the above principles are satisfied. Alternatively, the configuration of FIG. 4 can represent SONET ingress ports operating at M=2.5 G with four ingress ports (A=4) and a switching fabric operating at S=10 G. The egress ports can operate at N=622 Mbps with 16 ports (B=16). In this use case, M*A<=S and N*B<=S is satisfied. Hybrid examples where a number of ingress or egress ports have different data rates can also be supported by the present disclosure.

In yet another embodiment, the line module and port adapters of a bidirectional switching card can be configured by way of a software modification as an ingress-only switching card as shown in FIG. 5 for the purposes of queuing, scheduling, CPU resources, memory resources and so on. Likewise, the line module and port adapters of a bidirectional switching card can be configured by way of a software modification as an egress-only switching card as shown in FIG. 6 for the same or similar purposes to the ingress-only switching card.

With the aforementioned embodiments of unidirectional switching cards depicted by FIGS. 3-6 combined with conventional bidirectional switching cards, the asymmetric packet-switched network 101 of FIG. 2 can be readily constructed to accommodate asymmetric packet traffic with cost-effective utilization of physical and logical switch fabric resources of all switching cards. The illustrations of FIGS. 2-6 depict a packet-switching technique that substantially improves the utilization of packet-switching resources over prior art systems that attempt to produce the same asymmetric design by discarding otherwise useable ports in bidirectional switching cards.

FIG. 7 depicts a switching fabric that utilizes prior art bidirectional switching cards along with bidirectional switching cards reconfigured as unidirectional switching cards as described by the embodiments of FIGS. 3-6. The switching fabric of FIG. 7 illustrates, for example, a packet-switching router that supports both bidirectional and unidirectional switching cards to support a novel asymmetric network that utilizes switching resources more efficiently than prior art systems. In this embodiment packet switching can take place between any ingress and egress cards whether or not they are configured as bidirectional or unidirectional switching cards. Additionally, all ports of the reconfigured bidirectional switching cards are used in contrast to prior art systems that utilized bidirectional switching cards in asymmetric networks with unused ports.

Upon reviewing the aforementioned embodiments, it would be evident to an artisan with ordinary skill in the art that the present disclosure can be modified, reduced, or enhanced without departing from the scope and spirit of the claims described below. There are innumerable switching configurations that can be created with the reconfigured switching cards depicted by FIGS. 3-6. The reader is therefore directed to the claims for a fuller understanding of the breadth and scope of the present disclosure.

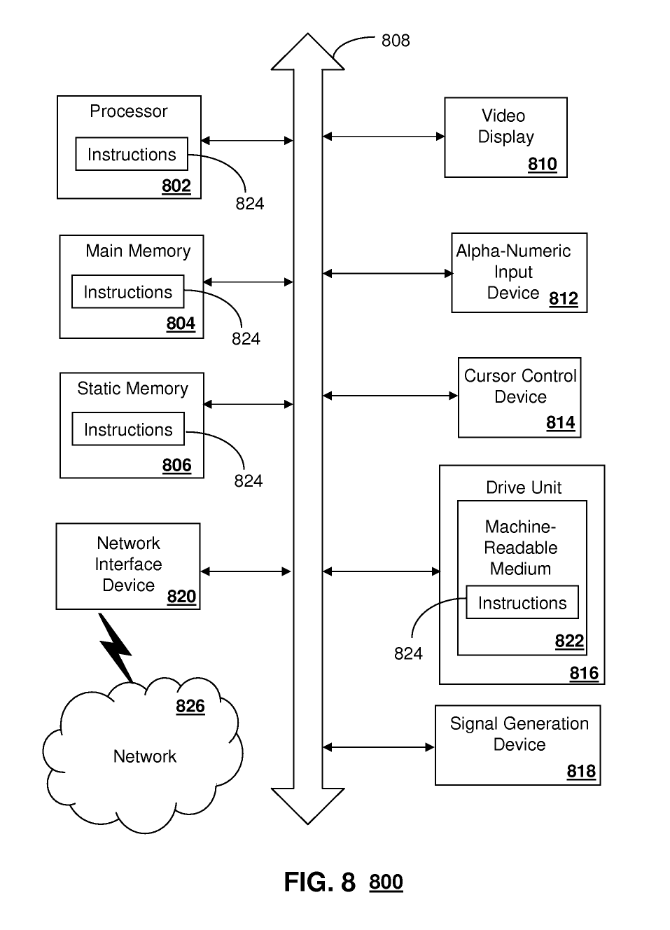

FIG. 8 depicts an exemplary diagrammatic representation of a machine in the form of a computer system 800 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a machine-readable medium 822 on which is stored one or more sets of instructions (e.g., software 824) embodying any one or more of the methodologies or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus, comprising a bidirectional switching card reconfigured as at least one among ingress and egress switching elements for transporting unidirectional packet traffic, wherein the bidirectional switching card comprises a line module and corresponding port adapters, and wherein logical portions of said line module and port adapters are reconfigured as the ingress and egress switching elements.

2. The apparatus of claim 1, wherein the ingress switching element receives ingress packets on one or more ingress ports at a given data rate, and wherein the egress switching element transmits portions of the ingress packets on one or egress ports at a subset of the data rate.

3. The apparatus of claim 1, wherein a number of ingress and egress ports of the ingress and egress switching elements have an M to N data rate ratio, wherein M represents a ports speed at the ingress switching element and N represents a port speed at the egress switching elements, wherein M and N are greater than or equal to one, wherein the apparatus comprises a switching fabric operating at a data rate denoted by S, wherein a number of ingress and egress switching elements have a number of ports denoted by A and B respectively, wherein an aggregate ingress data rate corresponding to the product of A and M is less than or equal to S, and wherein an aggregate egress data rate corresponding to the product of B and N is less than or equal to S.

4. The apparatus of claim 1, wherein the bidirectional switching card is an integral part of a switching fabric supporting unidirectional and bidirectional ingress and egress ports.

5. A network element, comprising a plurality of bidirectional switching cards each logically reconfigured as at least one among ingress and egress switching elements for transporting asymmetric unidirectional packet traffic.

6. The network element of claim 5, wherein each of the bidirectional switching cards comprise a line module and corresponding port adapters, and wherein operations of said line module and port adapters are logically reconfigured as the ingress and egress switching elements.

7. The network element of claim 5, wherein the ingress switching element receives ingress packets on one or more ingress ports at a given data rate, and wherein the egress switching element transmits portions of the ingress packets on one or egress ports at a subset of the data rate.

8. The network element of claim 5, wherein a number of ingress and egress ports of the ingress and egress switching elements have an M to N data rate ratio, wherein M represents a ports speed at the ingress switching element and N represents a port speed at the egress switching elements, wherein M and N are greater than or equal to one, wherein the apparatus comprises a switching fabric operating at a data rate denoted by S, wherein a number of ingress and egress switching elements have a number of ports denoted by A and B respectively, wherein an aggregate ingress data rate corresponding to the product of A and M is less than or equal to S, and wherein an aggregate egress data rate corresponding to the product of B and N is less than or equal to S.

9. The network element of claim 5, wherein the bidirectional switching card is an integral part of a switching fabric supporting unidirectional and bidirectional ingress and egress ports.

10. A computer-readable storage medium comprising computer instructions for arranging a bidirectional switching card as at least one among ingress and egress switching elements for transporting unidirectional packet traffic.

11. The storage medium of claim 10, wherein the bidirectional switching card comprises a line module and corresponding port adapters, and wherein logical portions of said line module and port adapters are reconfigured as the ingress and egress switching elements.

12. The storage medium of claim 10, wherein the ingress switching element receives ingress packets on one or more ingress ports at a given data rate, and wherein the egress switching element transmits portions of the ingress packets on one or egress ports at a subset of the data rate.

13. The storage medium of claim 10, wherein a number of ingress and egress ports of the ingress and egress switching elements have an M to N data rate ratio, wherein M represents a ports speed at the ingress switching element and N represents a port speed at the egress switching elements, wherein M and N are greater than or equal to one, wherein the apparatus comprises a switching fabric operating at a data rate denoted by S, wherein a number of ingress and egress switching elements have a number of ports denoted by A and B respectively, wherein an aggregate ingress data rate corresponding to the product of A and M is less than or equal to S, and wherein an aggregate egress data rate corresponding to the product of B and N is less than or equal to S.

14. The storage medium of claim 10, wherein the bidirectional switching card is an integral part of a switching fabric supporting unidirectional and bidirectional ingress and egress ports.

15. A method, comprising configuring a line module and corresponding port adapters of a bidirectional switching card as at least one among ingress and egress switching elements for transporting unidirectional packet traffic.

16. The method of claim 15, wherein the ingress switching element receives ingress packets on one or more ingress ports at a given data rate, and wherein the egress switching element transmits portions of the ingress packets on one or egress ports at a subset of the data rate.

17. The method of claim 15, wherein a number of ingress and egress ports of the ingress and egress switching elements have an M to N data rate ratio, wherein M represents a ports speed at the ingress switching element and N represents a port speed at the egress switching elements, wherein M and N are greater than or equal to one, wherein the apparatus comprises a switching fabric operating at a data rate denoted by S, wherein a number of ingress and egress switching elements have a number of ports denoted by A and B respectively, wherein an aggregate ingress data rate corresponding to the product of A and M is less than or equal to S, and wherein an aggregate egress data rate corresponding to the product of B and N is less than or equal to S.

18. The method of claim 15, wherein the bidirectional switching card is an integral part of a switching fabric supporting unidirectional and bidirectional ingress and egress ports.

19. The method of claim 15, comprising a plurality of the bidirectional switching cards for transport of unidirectional packet traffic having an asymmetric data rate.

20. A switch, comprising a plurality of bidirectional switching cards configured as at least one among ingress and egress switching elements with no unused ports for transporting unidirectional packet traffic for supporting unidirectional and bidirectional ingress and egress ports.
